(19) United States
(12) Patent Application Publication
(10) Pub. No.: US 2023/0038566 A1
(43) Pub. Date: Feb. 9, 2023

(54) METER SWITCH GUARD

(71) Applicant: E.J. Brooks Company d.b.a. Brooks Utility Products Group, Novi, MI (US)

(72) Inventor: David K. Gill, Ortonville, MI (US)

(73) Assignee: E.J. Brooks Company d.b.a. Brooks Utility Products Group

(21) Appl. No.: 17/393,704

(22) Filed: Aug. 4, 2021

(51) Int. Cl. H01H 9/02

(52) U.S. Cl. CPC H01H 9/02

(57) ABSTRACT

An electrical switch shield includes a base extending along a lateral axis and a longitudinal axis. The electrical switch shield includes a plurality of legs extending from the base along a vertical axis. The electrical switch shield includes a first clip and a second clip at opposing lateral sides of the base and spaced from each along the lateral axis.

### BACKGROUND

Buildings and other structures are typically electrically connected to an electrical grid that delivers power from a utility power source to the building. The utility power source may be, for example, a coal plant, a nuclear plant, a hydro-electric dam, a solar farm, a wind farm, etc. An electrical meter is installed at an electrical connection of the building to the electrical grid. The electrical meter, also known as a watthour meter, measures an amount electrical power consumed at the build and supplied via the electrical grid. The amount of electrical power measured electrical power may be used to determine how much a consumer should be billed by an operator of the utility power source.

A switch block having a plurality of switches moveable between open and closed positions that provide open and closed electrical circuits may be connected to the electrical grid, the meter, and/or electrical loads of the building. Various switches of the switch block may be placed in the open position and other switches of the switch block may be placed in the closed position, e.g., to open a circuit connected to the electrical grid and to close one or more circuits connected to the meter and the electrical loads. Such configuration may inhibit power from the electrical grid from flowing to the meter and electrical loads, while permitting testing of the meter and/or any electrical device such as a current transformer or voltage transformer that is connected, to ensure proper measure of electrical power consumed by the electrical loads.

### BRIEF DESCRIPTION OF THE DRAWINGS

FIG. 1 is a perspective view of a switch guard assembly attached to a switch block for controlling electrical connections to a meter.

FIG. 2 is a perspective view of the switch guard assembly attached to the switch block.

FIG. 3 is a cross section of the switch guard assembly attached to the switch block with a switch in an open position.

FIG. 4 is a perspective view of a pair of switch guards of the switch guard assembly.

FIG. 5 is a perspective view of a switch guard after a removable panel is removed.

FIG. 6 is a cross section of the switch guard of FIG. 5 attached to the switch block with a switch in the closed position.

### DETAILED DESCRIPTION

An assembly for selectively limiting access to switches of a switch block includes one or more electrical switch shields. Each of the electrical switch shields includes a base extending along a lateral axis and a longitudinal axis and includes a plurality of legs extending from the base along a vertical axis. Each of the electrical switch shields includes a first clip and a second clip at opposing lateral sides of the base and spaced from each along the lateral axis. The first clip of one of the electrical switch shields is releasably engageable with the second clip of another of the electrical switch shields. The base of each of the electrical switch shields may include one or more removable panels.

The assembly is attachable to the switch block and limits access to switches of the switch block. For example, the assembly may physically isolate one or more switches from objects external of the assembly and may inhibit actuation of one or more of the switches from an open position to a closed position. The electrical switch shields are attachable to each other at the first and second clips. Attaching multiple switch shields to each other permits customization of the assembly, e.g., to cover a desired number of switches of the switch block. Removal of one or more of the removable panels may provide access to a switch of the switch block that would have been otherwise inaccessible, to permit circuit testing to be conducted.

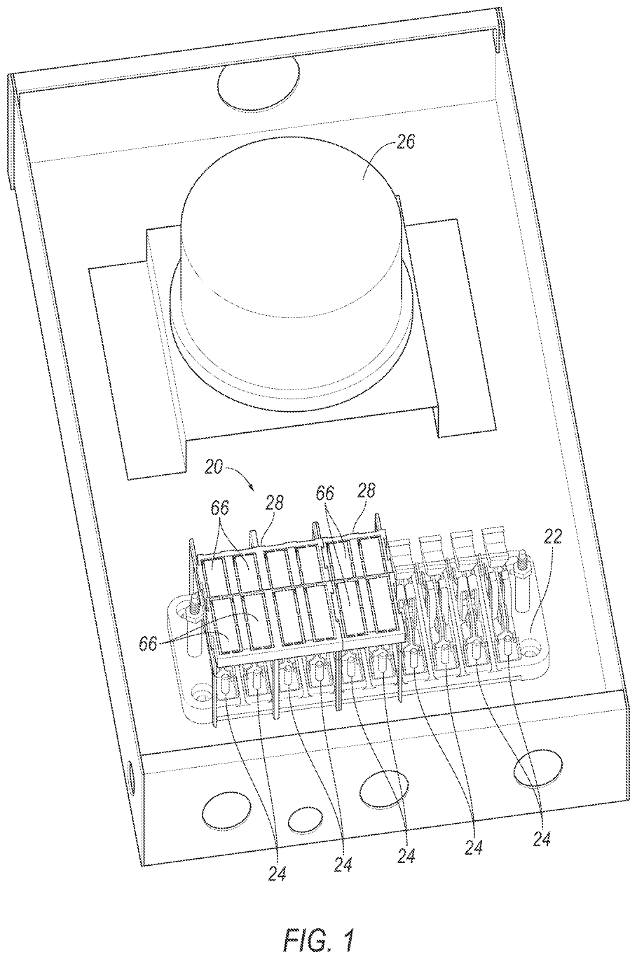

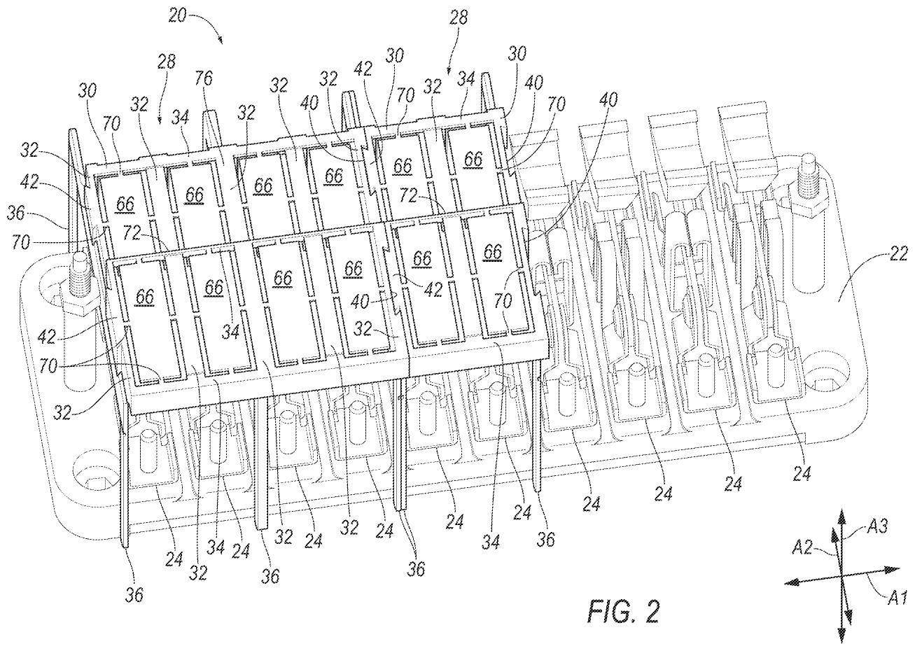

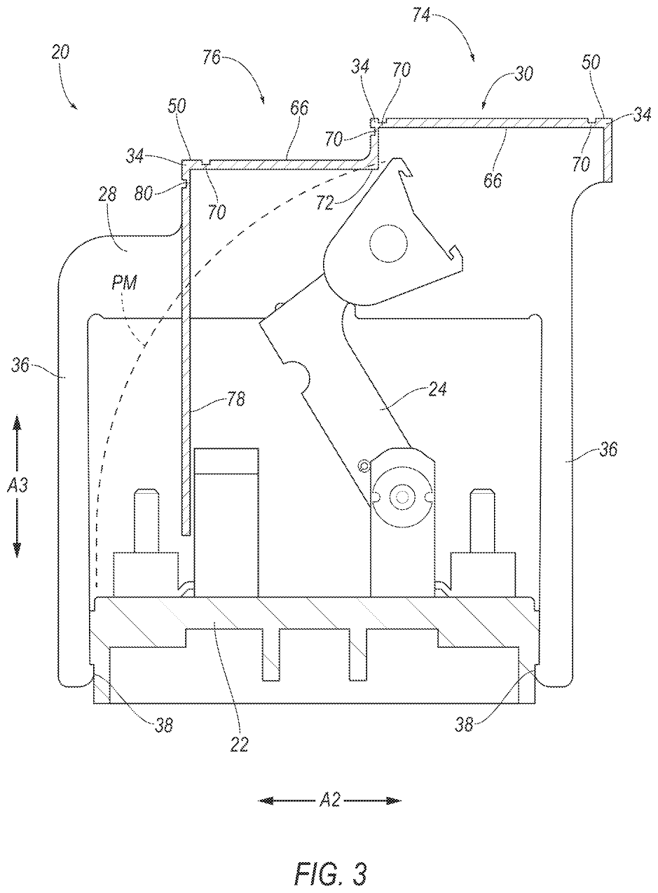

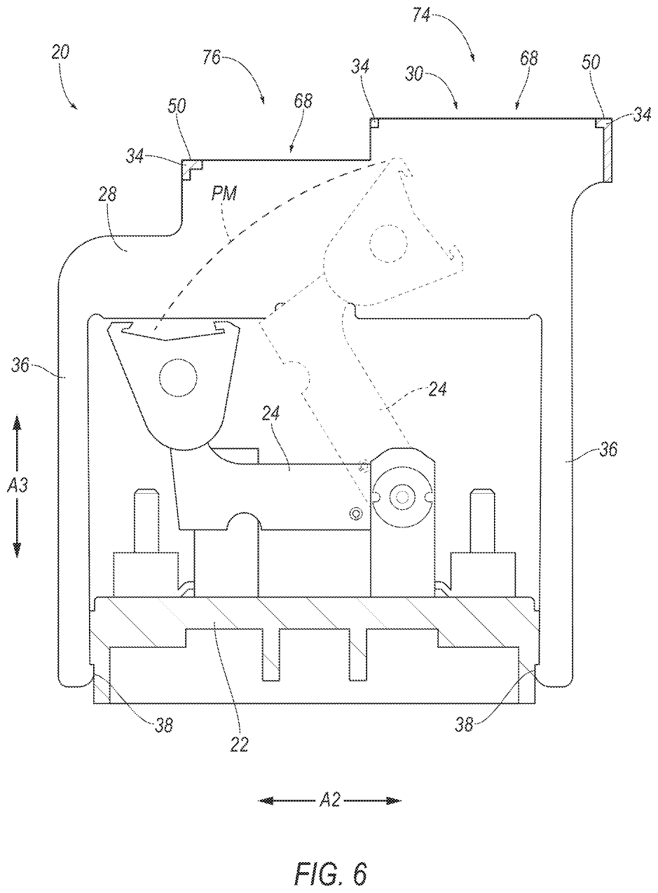

With reference to FIGS. 1 and 2, and wherein like numeral indicate like elements throughout the several views, a switch guard assembly 20 attached to a switch block 22 is shown. The switch guard assembly 20 covers and otherwise isolates switches 24 of the switch block 22. Each switch 24 is movable between an open position, shown in FIG. 3, and a closed position, shown in FIG. 6.

The switch guard assembly 20 is shown having a pair of switch guards 28 engaged with each other and attached to the switch block 22. Alternatively, the switch guard assembly 20 may have any other number of switch guards 28, i.e., only one or more than two (not shown).

With reference to FIGS. 2-6, each switch guard 28 includes a base 30 that extends along a lateral axis A1 and a longitudinal axis A2. The lateral axis A1 and the longitudinal axis A2 are perpendicular to each other. The base 30 may include a plurality of frame members, e.g., first frame members 32 elongated along the longitudinal axis A2 and second frame members 34 elongated along the lateral axis A1.

Each switch guard 28 includes a plurality of legs 36. The legs 36 extend from the base 30 of the respective switch guard 28 along a vertical axis A3. The vertical axis A3 is perpendicular to the lateral axis A1 and the longitudinal axis A2. The legs 36 may be spaced from each other along the vertical axis A3. Each of the legs 36 may extend away from the base 30 to a respective distal end. One or more of the legs 36 may each include a third clip 38 at the distal ends of the legs 36. The third clips 38 are releasably engageable with the switch block 22, enabling secure attachment and subsequent detachment of the switch guard 28. For example, the third clips 38 may protrude inwardly from the legs 36 along the longitudinal axis A2 and snap fit over a lip, bottom edge, opening, etc., of the switch block 22. The third clips 38 may have any other suitable shape for releasably engaging the switch block 22.

Each switch guard 28 includes a first clip 40 and a second clip 42. The first clip 40 of one of the shield guards is releasably engageable with the second clip 42 of another of the switch guards 28, enabling the switch guards 28 to be attached to each other. In other words, the first clip 40 and the second clip 42 are interlocking clips, i.e., interlockable with each other. The first switch guard 28 and the second switch guard 28 are spaced from each along the lateral axis A1, e.g., at opposing lateral sides of the base 30. The first clip 40 and the second clip 42 may include any suitable structure that enables the first clip 40 to be engaged with, and subsequently released from, the second clip 42.

The first clip 40 may be female and the second clip 42 may be male. In other words, the second clip 42 of one of the switch guards 28 may be received into the first clip 40 of another of the switch guards 28 when such switch guards 28 are engaged with each other. The second clip 42 of one of the switch guards 28 may be removed from within the first clip 40 of the other of the switch guards 28 when such switch guards 28 are disengaged from each other. The first clip 40 may have an inner surface 44 with a profile that corresponds to a profile of an outer surface 46 of the second clip 42. In other words, the inner surface 44 of the first clip 40 may mirror the outer surface 46 of the second clip 42.

The first clip 40 may include, for example, a channel 48 that defines a recess in the base 30. The channel 48 may extend along the vertical axis A3, e.g., downward from a top surface 50 of the base 30 to a stop 52 at a bottom of the channel 48. The channel 48 may be open at the top surface 50 of the base 30. The channel 48 maybe narrower at the bottom adjacent the stop 52 than at the top surface 50 of the base 30. For example, the channel 48 may taper as the channel 48 extends downward. The channel 48 is wider, e.g., along the longitudinal axis A2, at a channel inner end 54 and narrower at a channel outer end 56. The channel inner end 54 and the channel outer end 56 may be spaced from each other along the lateral axis A1. The channel inner end 54 may be between the frame members and the channel outer end 56. The channel outer end 56 may be open, e.g., along the vertical axis A3.

The second clip 42 may include, for example, a protrusion 58 extending away from the frame members along the lateral axis A1. The protrusion 58 may extend downward from the top surface 50 of the base 30 along the vertical axis A3, e.g., to a bottom. The protrusion 58 may be narrower at the bottom than at the top surface 50 of the base 30. For example, the protrusion 58 may taper as the protrusion 58 extends downward. The second clip 42 is wider, e.g., along the longitudinal axis A2, at a protrusion outer end 62 and narrower at a protrusion inner end 64. The protrusion inner end 64 and the protrusion outer end 62 may be spaced from each other along the lateral axis A1. The protrusion inner end 64 may be between the frame members and the protrusion outer end 62.

The first clip 40 of one of the guard shields may be engaged with the second clip 42 via insertion of the second clip 42 into the open top of the first clip 40. The protrusion 58 of the second clip 42 may be slid down into the channel 48 of the first clip 40, e.g., until the bottom of the second clip 42 abuts the stop 52. The first clip 40 may be released from engagement with the second clip 42 via sliding the protrusion 58 of the second clip 42 upward relative to the channel 48 of the first clip 40, and out the of the open top.

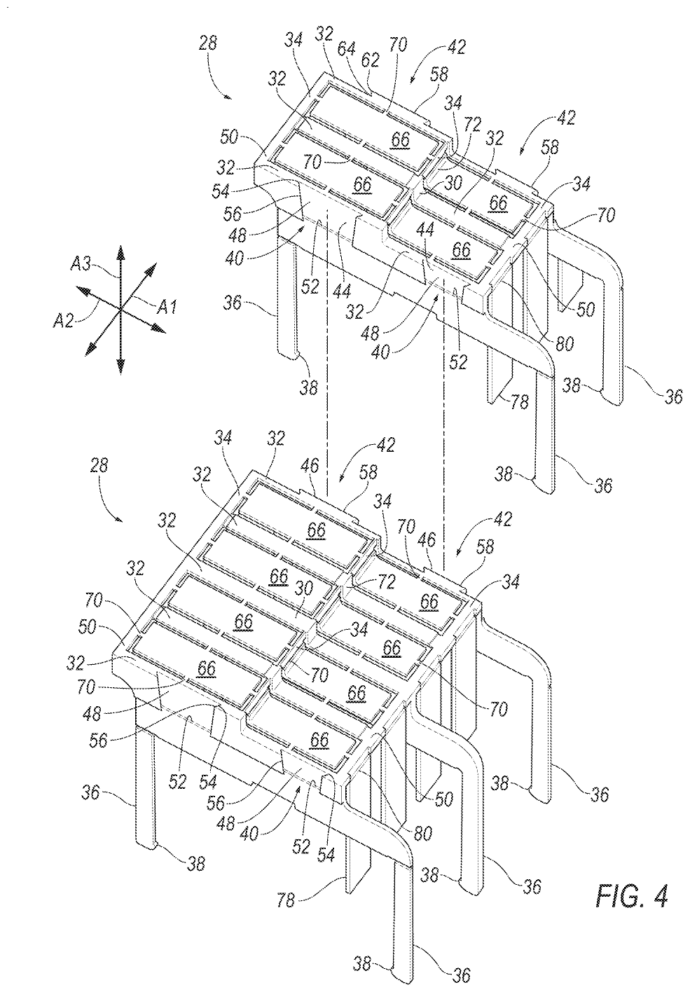

The base 30 may include one or more removable panels 66. Prior to removal the panels 66 may inhibit access to one or more switches 24 of the switch block 22, e.g., as shown in FIG. 3. Openings 68 formed upon removal of one or more of the panels 66 may enable access to one or more switches 24 of the switch block 22, e.g., as shown in FIG. 6. Each of the removable panels 66 may be longer along the lateral axis A1 and the longitudinal axis A2 than along the vertical axis A3. For example, the panels 66 may extend parallel to the lateral axis A1, parallel to the longitudinal axis A2, and perpendicular to the vertical axis A3. The panels 66 may be spaced from each other along the along the lateral axis A1, e.g., with the first frame members 32 therebetween. The panels 66 may be spaced from each other along the longitudinal axis A2, e.g., with the second frame members 34 therebetween. The panels 66 may be arranged in pairs, e.g., with each pair corresponding to one of the switches 24 of the switch block 22. The panels 66 of such pair of panels 66 may be spaced from each other along the longitudinal axis A2. The pairs may be spaced from each other along the lateral axis A1, e.g., with the number of pairs equal to a number of switches 24 covered by the switch 24 shield. For example, the base 30 of one of the switch guards 28 may include two pairs of removable panels 66 and the base 30 another of the switch guard 28 may include four pairs of removable panels 66, as shown in FIGS. 2 and 4. The base 30 may include any number of removable panels 66 or pairs of removable panels 66.

The panels 66 may be attached with one or more frangible members 70 that enable removal of the panel 66. For example, application of force to one of the panels 66 may break the frangible members 70 attached to such panel 66. The frangible members 70 may include, for example, strips of material connecting the removable panels 66 to the first frame members 32 and/or the second frame members 34. The base 30 may include any other suitable structure to enable removal of the panels 66, e.g., a tear seam, a pull tab, a perforation, etc.

The base 30 may include a step 72 extending along the vertical axis A3. The step 72 inhibits actuation of one or more of the switches 24 of the switch block 22. For example, and with reference to FIG. 3, the step 72 may block a path of motion PM of one or more of the switches 24 and prevent such switches 24 from moving to the closed positions. The step 72 may extend along lateral axis A1, e.g., separating a top portion 74 of the base 30 from a bottom portion 76 of the base 30. The top portion 74 may be spaced from the bottom potion along the vertical axis A3 and along the longitudinal axis A2. The step 72, or a portion of the step 72, may be provided by one or more of the removable panels 66, e.g., the removable panels 66 at the bottom portion 76 of the base 30. For example, and with reference to FIG. 6, removal of one or more of the panels 66 may concurrently remove the step 72 corresponding to the removed panel 66, unblocking the path of motion PM of one or more of the switches 24.

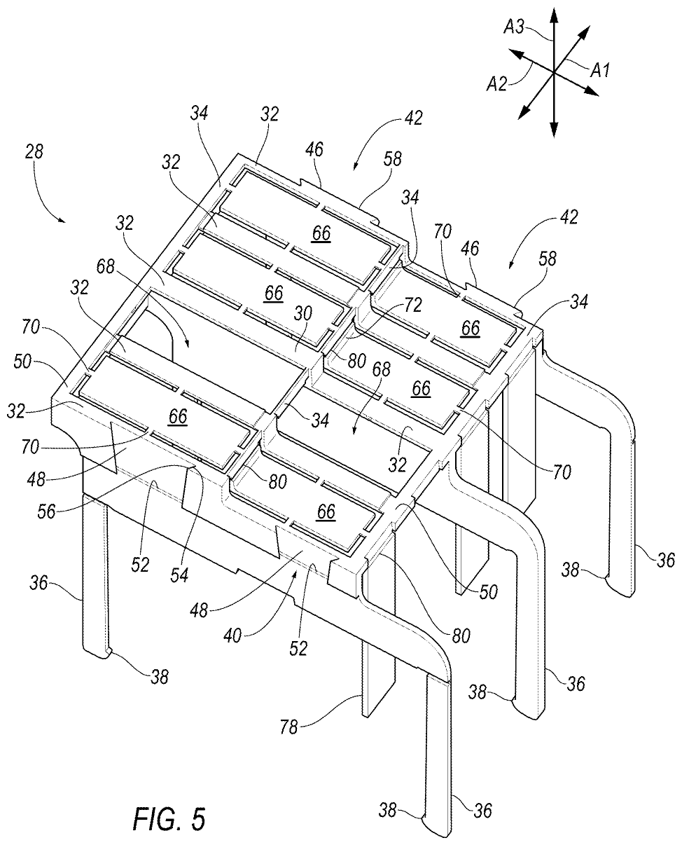

Each switch guard 28 may include one or more blocking panels 78. The blocking panels 78 isolate one or more of the switches 24, e.g., from objects external of the switch guard 28. The blocking panels 78 extend away from the base 30 along the vertical axis A3. The blocking may extend along the lateral axis A1. The blocking panel 78 may extend perpendicular to the longitudinal axis A2. The blocking panel 78 is connected to the base 30 with a second frangible member 80, i.e., enabling removal of the blocking panel 78 to provide access to the switch 24 isolated by such blocking panel 78. The switch guard 28 with one of the blocking panels 78 removed is shown in FIGS. 5 and 6. The second frangible member 80 may be, for example, a seam of material connecting the base 30 to the blocking panel 78. The seam may be thinner, e.g., along the longitudinal axis A2, than the base 30 and the blocking panel 78 adjacent the seam. The seam may be elongated along the lateral axis A1, e.g., extending across an entirety of the blocking panel 78.

The adjectives first and second are used throughout this document as identifiers and, unless explicitly stated otherwise, are not intended to signify importance, order, or quantity.

The disclosure has been described in an illustrative manner, and it is to be understood that the terminology which has been used is intended to be in the nature of words of description rather than of limitation. Many modifications and variations of the present disclosure are possible in light of the above teachings, and the disclosure may be practiced otherwise than as specifically described.

1. An electrical switch shield comprising:
a base extending along a lateral axis and a longitudinal axis;
a plurality of legs spaced from each other along the longitudinal axis and extending from the base along a vertical axis; and
a first clip and a second clip at opposing lateral sides of the base and spaced from each along the lateral axis.

2. The electrical switch shield of claim 1, wherein the first clip is female and the second clip is male.

3. The electrical switch shield of claim 1, wherein the first clip has an inner surface profile that corresponds to an outer surface profile of the second clip.

4. The electrical switch shield of claim 1, wherein the first clip includes a channel extending along the vertical axis.

5. The electrical switch shield of claim 4, wherein the channel is wider at an inner end and narrower at an outer end, the inner end and the outer end spaced from each other along the lateral axis.

6. The electrical switch shield of claim 1, wherein the second clip is wider along the longitudinal axis at an outer end and narrower along the longitudinal axis at an inner end, the inner end and the outer end spaced from each other along the lateral axis.

7. The electrical switch shield of claim 1, wherein each leg of the plurality of legs includes a third clip at a distal end of the each leg of the plurality of legs.

8. The electrical switch shield of claim 1, wherein the base includes a step extending along the vertical axis.

9. The electrical switch shield of claim 1, wherein the base includes a removable panel between the first clip and the second clip along the lateral axis.

10. The electrical switch shield of claim 1, further comprising a blocking panel extending from the base along the vertical axis.

11. The electrical switch shield of claim 10, wherein the blocking panel is connected to the base with a frangible member that breaks to enable removal of the removable panel.

12. An electrical switch shield comprising:
a base extending along a lateral axis and a longitudinal axis, the base including a removable panel that is longer along the lateral axis and the longitudinal axis than along a vertical axis; and
a plurality of legs extending from the base along the vertical axis;
wherein the removable panel is attached with one or more frangible members that break to enable removal of the removable panel.

13. (canceled)

14. The electrical switch shield of claim 12, wherein the base includes a second removable panel spaced from the removable panel along the lateral axis.

15. The electrical switch shield of claim 14, wherein the base includes a third removable panel spaced from the removable panel along the longitudinal axis.

16. The electrical switch shield of claim 12, wherein the base includes a step extending along the vertical axis.

17. The electrical switch shield of claim 12, further comprising a first clip and a second clip at opposing lateral sides of the base and spaced from each along the lateral axis.

18. An assembly, comprising:
a first electrical switch shield having a first base extending along a first lateral axis and a first longitudinal axis, a first plurality of legs extending downward from the first base along a first vertical axis, and a first clip at a first lateral side of the first base;
a second electrical switch shield having a second base extending along a second lateral axis and a second longitudinal axis, a second plurality of legs extending downward from the second base along a second vertical axis, and a second clip at a second lateral side of the second base; and
the first clip is releasably engageable with the second clip.

19. The assembly of claim 18, further comprising a switch block having a plurality of switches movable between an open position and a closed position, and wherein at least one leg of the first plurality of legs includes a third clip that is releasably engageable with the switch block.

20. The assembly of claim 19, wherein the first base includes a step that inhibits actuation of at least one switch of the plurality of switches of the switch block to the closed position.
